(19) United States
(12) Patent Application Publication
(10) Pub. No.: US 2009/0077187 A1
(43) Pub. Date: Mar. 19, 2009

(54) METHOD AND APPARATUS FOR COMMUNICATIONS

(76) Inventor: Yoshikazu AZUMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/207,900

(22) Filed: Sep. 10, 2008

(30) Foreign Application Priority Data
Sep. 14, 2007 (JP) 2007-238987

(51) Int. Cl. G06F 15/16; H04L 9/32

(52) U.S. Cl. 709/206; 726/4; 709/228

(57) ABSTRACT

A communication apparatus working as a sub-device wirelessly transmits/receives encrypted data to/from a plurality of communication apparatuses working as main-devices. Upon detecting a plurality of connectable main-devices, the sub-device determines a target main-device for establishing communication based on priority of the detected main-devices. When the sub-device is disconnected from the main-device with which it is communicating, the sub-device automatically switches to another connectable main-device based on the priority of the detected main-devices.

### CROSS-REFERENCE TO RELATED APPLICATIONS

The present application claims priority to and incorporates by reference the entire contents of Japanese priority document 2007-238987 filed in Japan on Sep. 14, 2007.

### BACKGROUND OF THE INVENTION

1. Field of the Invention

The present invention relates to a method and an apparatus for wireless communications.

2. Description of the Related Art

With the rapid development in the field of wireless communications, various wireless communication apparatuses have been developed (see, for example, Japanese Patent Application Laid-open No. 2006-197248 and Japanese Patent Application Laid-open No. 2004-80755). A wireless communication apparatus can communicate with another wireless communication apparatus only after establishing a wireless link with that wireless communication apparatus. Because in wireless communication the wireless communication apparatuses communicate with each other wirelessly, in contrast to wired communications where the apparatuses are in physical contact with each other, a third party can maliciously intercept the communication.

Some of wireless communication apparatuses transmit/receive encrypted data to prevent such maliciously interception by a third party. When two of such wireless communication apparatuses establish communications for the first time, they exchange connection information including identification data and an encryption key that is used to encrypt data thereby sharing the connection information. Some of wireless-communication topologies assume a system that includes a single communication apparatus working as a main-device and at least one communication apparatus working as a sub-device in which the main-device is connected to the sub-device and controls the system.

In a wireless-communication system based on, for example, a wireless universal serial bus (WUSB) standard that uses an ultra wideband (UWB) technology or the like, there are a WUSB host working as the main-device and a WUSB device working as the sub-device. When the WUSB host and the WUSB device make the first connection, the WUSB host and the WUSB are associated to each other by exchanging and sharing of the connection information, and store therein the connection information as a connection context (CC). The WUSB host and the WUSB device make the second or successive connections by performing authentication/key-exchange using the stored CC.

Some users install the above-described wireless communication function in a plurality of devices used in an office, and form a wireless communication system as a workgroup. Such a workgroup can be configured to include a single sub-device and a plurality of main-devices sharing the single sub-device, in which each main-device is connectable to the sub-device. For example, the workgroup includes a printer as the single sub-device and a plurality of personal computers or movable terminals as the main-devices, in which each main-device is connectable to the sub-device.

The main-device stores therein the connection information about all the sub-devices to which the main-device is connectable. On the other hand, it is enough for the sub-device to store therein the connection information about only one main-device to which the sub-device is connectable. However, if the sub-device includes an application that is commonly used by a plurality of main-devices, it is necessary for the sub-device to store therein the connection information about each of the main-devices. Assume that a memory area of the sub-device is such small that it can store therein the connection information of only one main-device. In this example, to share the connection information with the target main-device to be connected, the sub-device has to exchange the connection information and update the exchanged connection information stored in the memory area each time the sub-device switches to another main-device. If the sub-device frequently switches to another main-device, i.e., various main-devices frequently use the sub-device, the sub-device has to frequently exchange the connection information, which makes time it takes to make the connection longer and decreases the usability remarkably.

To quickly establish the connection with any one of the main-devices, the sub-device preferably stores therein the connection information about each main-device having a possibility to make a connection with the sub-device. Moreover, if there is a plurality of main-devices connectable to the sub-device, the sub-device needs to select an appropriate main-device to be connected.

### SUMMARY OF THE INVENTION

It is an object of the present invention to at least partially solve the problems in the conventional technology.

According to an aspect of the present invention, there is provided a communication apparatus that works as a sub-device and wirelessly transmits/receives encrypted device identification data and encrypted communication data to/from a plurality of communication apparatuses that works as main-devices. The communication apparatus working as the sub-device includes a storage unit that stores therein connection information that includes an encryption key and device identification data, the encryption key being used to encrypt information to be transmitted; a detecting unit that detects a main device connectable to the sub-device; a specifying unit that specifies, when the detecting unit detects a first main-device and a second main-device as main devices connectable to the sub-device, the first main-device as a target main-device to be connected from among the first main-device and the second main-device based on priority information about the first main-device and the second main-device; and a communicating unit that wirelessly communicates with the target main-device by using the connection information corresponding to the target main-device in the storage unit. When the detecting unit detects a third main-device connectable to the sub-device while the communicating unit is communicating with the first main-device, the specifying unit re-specifies a target main-device to be connected from among the main-devices connectable to the sub-device based on the priority.

According to another aspect of the present invention, there is provided a communication method of communicating between a communication apparatus that works as a sub-device and wirelessly transmits/receives encrypted device identification data and encrypted communication data to/from a plurality of communication apparatuses that works as main-devices. The communication apparatus working as the sub-device performs detecting a main device connectable to the sub-device; specifying, when a first main-device and a second main-device are detected at the detecting as main devices connectable to the sub-device, the first main-device as a target main-device to be connected from among the first main-device and the second main-device based on priority information about the first main-device and the second main-device; and establishing wirelessly communication with the target main-device by using the connection information corresponding to the target main-device stored in a storage unit. When a third main-device connectable to the sub-device is detected at the detecting while the communicating unit is communicating with the first main-device, the specifying includes re-specifies a target main-device to be connected from among the main-devices connectable to the sub-device based on the priority.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a wireless communication system according to an embodiment of the present invention;

FIG. 2 is a block diagram of a sub-device shown in FIG. 1;

FIG. 3 is an example of data structure of connection information that is stored in a nonvolatile memory shown in FIG. 2;

FIG. 4 is an example of data structure of connection log-data that is stored in the nonvolatile memory;

FIG. 5 is an example of a log-in screen with which a user having an administrative right logs in;

FIG. 6 is an example of a setting screen with which the user set switching conditions;

FIG. 7 is a flowchart of a specifying process according to the embodiment;

FIG. 8 is a schematic diagram of a situation where the sub-device is disconnected from a main-device as the main-device moves out of the communication range of the sub-device; and

FIG. 9 is a schematic diagram of a situation where the sub-device switches to another main-device in response to a switch command received from the user.

### DETAILED DESCRIPTION OF THE PREFERRED EMBODIMENTS

Exemplary embodiments of the present invention are described in detail below with reference to the accompanying drawings.

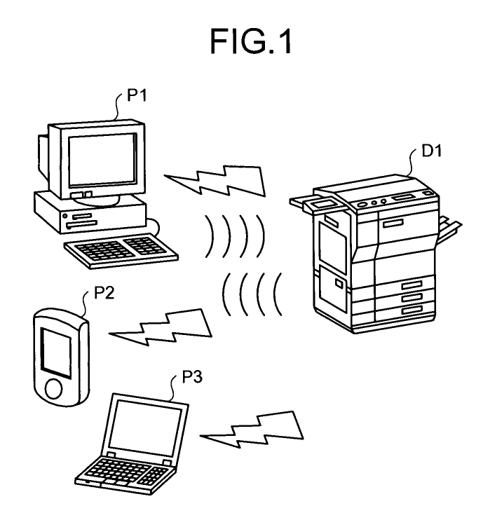

FIG. 1 is a schematic diagram of the structure of a wireless communication system according to an embodiment of the present invention. The wireless communication system includes a plurality of wireless communication apparatuses P1, P2, P3, and D1. It is assumed that the wireless communication apparatuses P1, P2, and P3 work as main-devices and the wireless communication apparatus D1 works as a sub-device D1. The main-devices P1 to P3 can be personal computers or the like. More particularly, the main-devices P2 and P3 can be movable information apparatuses such as mobile personal computers. The sub-device D1 is a multifunction product (MFP) having functions such as a printer function, a scanner function, and a storage function. The sub-device D1 wirelessly communicates with one or more of the main-devices P1 to P3 by encrypting device ID and communication data based on, for example, the WUSB standard. The device ID is information for identifying each of the devices. The communication data is, for example, a print command that instructs the sub-device D1 to print an image. In the following description, an arbitrary one or more of the main-devices from among the main-devices P1 to P3 will be referred to as a main-device P for the sake of simplicity.

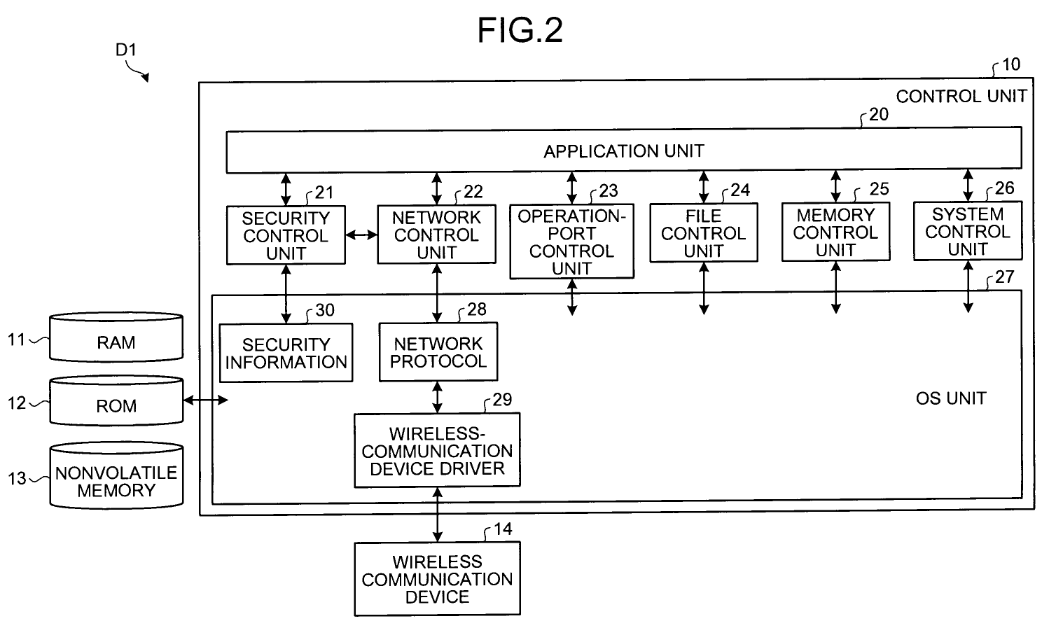

FIG. 2 is a block diagram of the sub-device D1. The sub-device D1 includes a control unit 10, a random access memory (RAM) 11, a read only memory (ROM) 12, a nonvolatile memory 13, and a wireless communication device 14. The control unit 10 includes a central processing unit (CPU) (not shown). The control unit 10 reads various computer programs from the ROM 12 and executes the read computer programs thereby implementing various functions.

The RAM 11 is used as a work area by the control unit 10 to execute the computer programs. The ROM 12 stores therein the various computer programs and various data. The nonvolatile memory 13 stores therein connection information that is shared with the main-device P, connection log-data, an automatic switch flag, and a forced switch flag. The connection information includes a main-device ID for identifying the main-device P, a sub-device ID for identifying the sub-device D1, and an encryption key for encrypting information including the main-device ID, the sub-device ID, and the communication data for wireless transmission. The nonvolatile memory 13 stores therein the connection information that is shared with each of the main-devices P1 to P3. When the control unit 10 implements the storage function, the nonvolatile memory 13 is ready to store therein image data. The wireless communication device 14 wirelessly communicates with an external wireless communication apparatus such as the main-devices P1 to P3.

Although not shown in FIG. 2, the sub-device D1 includes a first engine unit that works as a printer, a second engine unit that works as a scanner, an application specific integrated circuit (ASIC) that processes an image to be printed or an image obtained by scanning, and an operation panel. The operation panel includes a receiving unit that receives various commands from the user and a displaying unit that displays various information for the user to view.

Functional units of the control unit 10 are described below. The control unit 10 includes an operating system (OS) unit 27, an application unit 20, a security control unit 21, a network control unit 22, an operation port control unit 23, a file control unit 24, a memory control unit 25, and a system control unit 26. The OS unit 27 includes storage units for storing therein security information 30, a network protocol 28, and a wireless-communication device driver 29, and works as the OS. The network protocol 28 is a protocol stack for wireless encrypted communications. The wireless-communication device driver 29 is used to control the wireless communication device 14. The application unit 20 includes an application for encrypted communications and an association application for exchanging the connection information with the main-device P. The application unit 20 includes a printer application for implementing the printer function, a scanner application for implementing the scanner function, a storage application for implementing the storage function. Those applications are shared by the main-devices P1 to P3. The application unit 20, the network control unit 22, the network protocol 28, the wireless-communication device driver 29, and the security control unit 21 work together to wirelessly communicate with the main-device P based on the UWB technology. The security control unit 21 stores security information including the connection information in the nonvolatile memory 13. The operation port control unit 23 receives commands from the user via the operation panel, and displays information on the operation panel. The file control unit 24 reads/writes a file. The memory control unit 25 reads/writes data from/to a memory such as the RAM 11, the ROM 12, and the nonvolatile memory 13. The system control unit 26 controls those functional units 20 to 30.

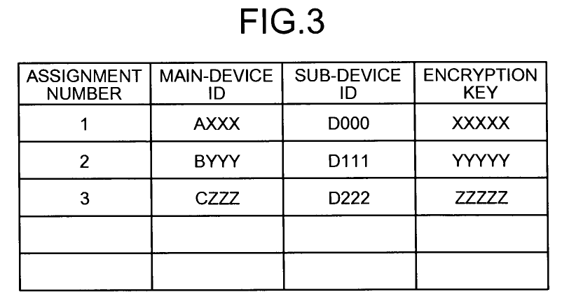

The data structure of the connection information that is stored in the nonvolatile memory 13 is described below with reference to FIG. 3. The connection information includes the main-device ID for identifying the main-device P, the sub-device ID for identifying the sub-device D1, and the encryption key for encrypting information including the main-device ID, the sub-device ID, and the communication data before starting wireless communications. The first row in the table shown in FIG. 3 indicates the communication information shared by the main-device P1 and the sub-device D1; the second row indicates the communication information shared by the main-device P2 and the sub-device D1; and the third row indicates the communication information shared by the main-device P3 and the sub-device D1.

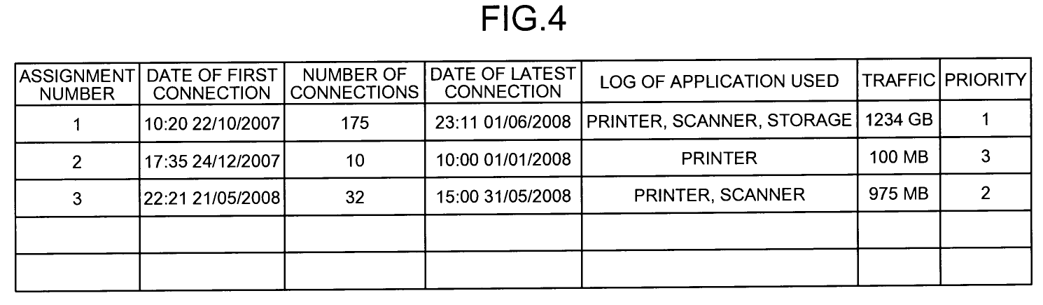

The data structure of the connection log-data that is stored in the nonvolatile memory 13 is described below with reference to FIG. 4. The connection log-data indicates a log of connection of the sub-device D1 with each of the main-devices P. The connection log-data is associated with the connection information by, for example, assignment number. The first row in the table shown in FIG. 4 is a log of connection of the sub-device D1 with the main-device P1, for example. The second row is a log of connection of the sub-device D1 with the main-device P2, and the third row is a log of connection of the sub-device D1 with the main-device P3.

The connection log-data includes date of first connection, number of connections (connection frequency), date of latest connection, log of application used, traffic, and priority. The date of first connection is the time and the date on which the sub-device D1 wirelessly communicated with the main-device P for the first time. The number of connections represents the number of times the sub-device D1 established connection with the main-device P. The date of latest connection represents the latest time and the latest date on which the sub-device D1 established connection with the main-device P. The log of application used represents a type of application used from among the printer application, the scanner application, and the storage application by the main-device P. The traffic is an amount of data wirelessly transferred between the sub-device D1 and the main-device P. The priority is used to specify a target main-device to be connected from among the main-devices P1 to P3. The priority depends on a parameter (hereinafter, “priority parameter”). As described later, the user specifies the priority parameter by, for example, inputting a command via the operation panel. The user can specify as the priority parameter the device ID (i.e., main-device ID and sub-device ID), the connection log-data including the number of connections, the traffic, elapsed time since the date of first connection, elapsed time since the date of latest connection, and a type of used applications, and an arbitrary parameter. If, for example, the number of connections is set as the priority parameter, the larger the number of connections is the higher the priority becomes. In the example shown in FIG. 4, the main-device P1 has the first priority, the main-device P2 has the third priority, and the main-device P3 has the second priority.

When the sub-device D1 wirelessly communicates with the main-device P for the first time, the date of first connection is stored in the connection log-data. Each time the sub-device D1 wirelessly communicates with the main-device P after that, the date of latest connection, the number of connections, and the log of application used in the connection log-data are updated.

The sub-device D1 identifies the type of applications used from, for example, the communication data received from the main-device P. More particularly, if the communication data includes a print command that instructs to print an image, the sub-device D1 determines that the printer function is used. If the communication data includes a scan command that instructs to scan an image, the sub-device D1 determines that the scanner function is used. If the communication data includes a store command to that instructs store an image, the sub-device D1 determines that the storage function is used. The sub-device D1 stores either the total traffic from the first to the latest connections or the traffic only at the latest connection. The sub-device D1 re-calculates the priority each time the priority parameter (e.g., the number of connections) is updated. Alternatively, the sub-device D1 re-calculates the priority when predetermined timing has come or in response to a command from the user. As described later, the priority parameter is stored in the nonvolatile memory 13. The sub-device D1 reads the priority parameter from the nonvolatile memory 13 and calculates the priority from the priority parameter.

The automatic switch flag indicates an automatic-switching mode that will be described in detail later. The user sets the automatic switch flag to ON/OFF by inputting a command via the operation panel. The forced switch flag indicates a forced-switching mode that will be described in detail later. The user sets the forced switch flag to ON/OFF by inputting a command via the operation panel.

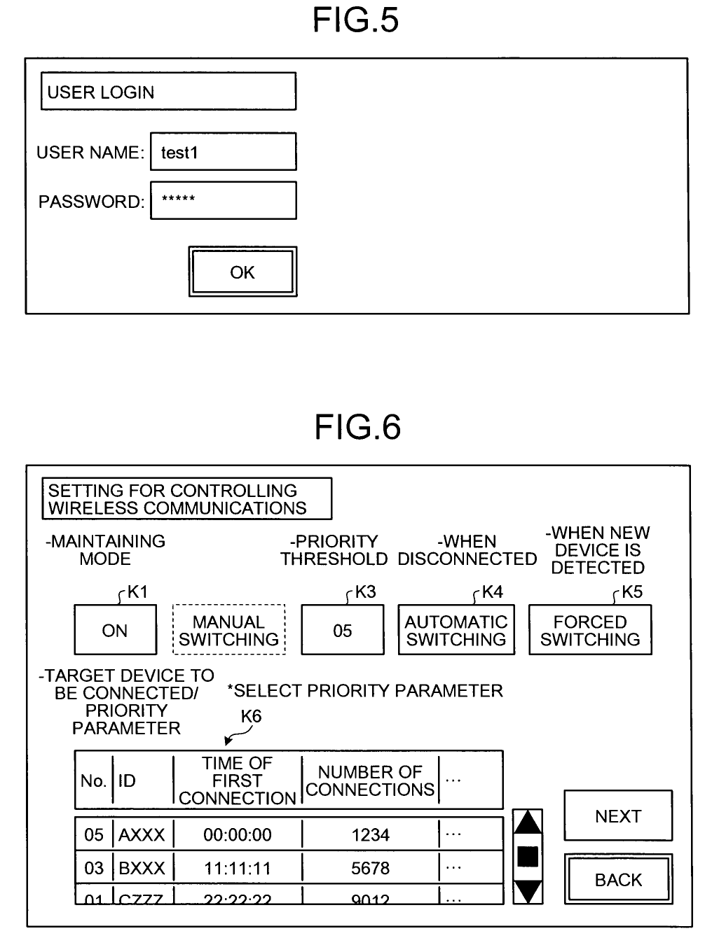

FIGS. 5 and 6 are examples of screens displayed on the operation panel. FIG. 5 is an example of a log-in screen with which the user having the administrative right logs in. FIG. 6 is an example of a setting screen with which the user set various switching conditions. When the user enters a correct user name and a correct password, and presses an OK button on the log-in screen shown in FIG. 5, the setting screen shown in FIG. 6 appears on the operation panel.

The user sets the switching conditions for switching to the target main-device to be connected with the setting-screen shown in FIG. 6. More particularly, the switching conditions include a maintaining mode, the automatic-switching mode, the forced-switching mode, and the priority parameter. The automatic-switching mode and the forced-switching mode can be set to ON when the maintaining mode is OFF. If the maintaining mode is set to ON with a K1 button shown in FIG. 6, the automatic switch flag is set to OFF. If the maintaining mode is ON, after the sub-device D1 establishes connection with the main-device P, the sub-device D1 tries to maintain the connection with the same main-device P. For example, when the sub-device D1 is temporarily disconnected from the main-device P due to some reasons, the sub-device D1 makes a re-connection with the same main-device P without switching to another main-device P.

If the user sets the maintaining mode to OFF, the user sets the automatic-switching mode with a K4 button and the forced-switching mode with a K5 button, respectively. If the automatic-switching mode is ON, upon disconnected from the main-device P, the sub-device D1 automatically switches to another main-device P. If the forced-switching mode is ON, upon detecting a main-device P connectable to the sub-device D1 but undetected at the prior detection (hereinafter, “new main-device P”) and determining that the priority of the new main-device P is higher than that of the main-device that is currently connected to the sub-device D1 (hereinafter, “current main-device P”), the sub-device D1 switches to the new main-device. If the automatic-switching mode is ON, the automatic switch flag is set to ON. If the forced-switching mode is ON, the forced switch flag is set to ON.

The user sets the priority parameter in a K6 area. The priority parameter can be any one of or a combination of two or more of parameters listed on the K6 area. When the user finishes setting those modes and parameters on the setting screen, the specified settings are stored in the storage unit such as the nonvolatile memory 13.

Before the sub-device D1 makes the first connection with the main-device P, the control unit 10 of the sub-device D1 and the main-device P authenticates each other. The control unit 10 generates the connection information in response to a request received from the main-device P, and stores the generated connection information in the nonvolatile memory 13. The sub-device D1 stores the current date in the connection log-data as the date of first connection. The control unit 10 transmits the connection information to the target main-device P to be connected via the wireless communication device 14. Upon receiving the connection information from the sub-device D1, the main-device P stores therein the connection information. In this manner, the sub-device D1 shares the connection information with each of the main-devices P1 to P3. The sub-device D1 updates the connection log-data each time the sub-device D1 makes a second or successive connection with the main-device P. The main-device P periodically broadcasts a beacon signal. At the beginning of the second or successive connection, the control unit 10 performs a scanning process for detecting a beacon signal coming from the main-device P. Upon detecting a beacon signal, the control unit 10 performs processes such as the authentication/key-exchange using the connection information, and wirelessly communicates with the main-device P from which the beacon signal is received.

The authentication/key-exchange is performed in a conventional manner, and therefore the explanation about the authentication/key-exchange is omitted. Upon detecting a plurality of beacon signals coming from different main-devices P, the control unit 10 reads the priority in the connection log-data from the nonvolatile memory 13, and specifies based on the priority the target main-device P to be connected from among the main-devices p, and wirelessly communicates with the specified main-device P via the wireless communication device 14. As a result, the sub-device D1 is connected to the specified main-device P, and the wireless link is built between the sub-device D1 and the specified main-device P.

The control unit 10 determines whether the automatic-switching mode is ON. If the automatic-switching mode is ON, when the sub-device D1 is disconnected from the current main-device P due to some reasons, the control unit 10 automatically searches for a main-device P connectable to the sub-device D1 and automatically switches to an appropriate main-device P based on the priority. The control unit 10 determines whether the forced-switching mode is ON. If the forced-switching mode is ON, upon detecting the new main-device P and determining that the priority of the new main-device P is higher than the current main-device P, the control unit 10 switches, even if the current main-device P is connectable to the sub-device D1, from the current main-device P to the new main-device P. If the automatic-switching mode is OFF, the control unit 10 switches to another main-device P only when the user inputs a switch command via the operation panel.

The main-device P includes a CPU, a storage unit such as a RAM and a ROM, a communication unit that wirelessly communicates with the sub-device D1, and a bus that connects those units to each another, as hardware so that a ordinal computer can be used as the main-device P. Those units of the main-device P are not shown in the drawings. The main-device P wirelessly communicates with the sub-device D1 via the communication unit based on the WUSB standard.

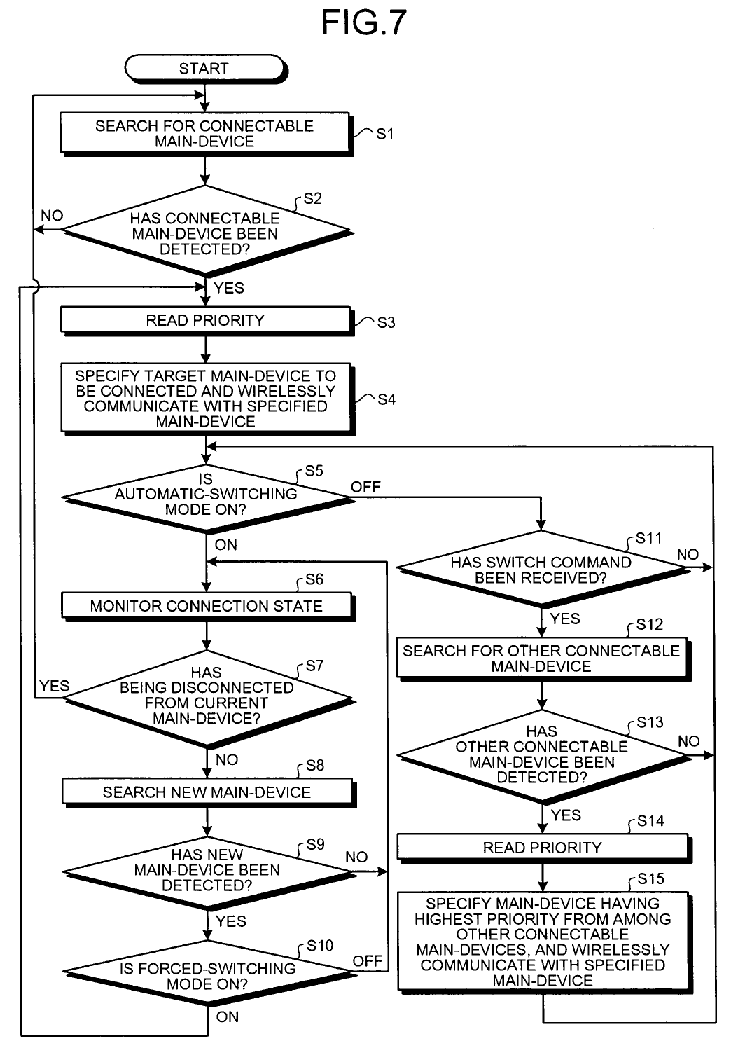

A specifying process for specifying the target main-device P to be connected according to the present embodiment is described below with reference to FIG. 7. It is assumed that the control unit 10 of the sub-device D1 shares the connection information with each of the main-devices P1 to P3. The control unit 10 searches for the main-device P connectable to the sub-device D1 (hereinafter, “connectable main-device P”) (Step S1). More particularly, the sub-device D1 performs the scanning process for detecting a beacon signal coming from the main-device P. When the control unit 10 detects the beacon signal (Yes at Step S2), the control unit 10 determines that the main-device P from which the beacon signal is emitted as the connectable main-device P. If the control unit 10 detects a plurality of beacons signals, the control unit 10 determines that there is a plurality of connectable main-devices P. It is assumed here that the sub-device D1 detects only the main-device P2 as the connectable main-device P. The control unit 10 reads the priority from the storage unit such as the nonvolatile memory 13 (Step S3). The control unit 10 specifies the target main-device P to be connected based on the priority. More particularly, the control unit 10 specifies the main-device P2 as the target main-device P regardless of the priority because the main-device P2 is the only connectable main-device P. The control unit 10 performs the authentication/key-exchange process by exchanging the connection information with the main-device P2, and wirelessly communicates with the main-device P2 via the wireless communication device 14 (Step S4). As a result, the sub-device D1 is connected to the main-device P2, and a wireless link is built between the sub-device D1 and the main-device P2.

The control unit 10 determines whether the automatic-switching mode is ON by referring to the automatic switch flag stored in the nonvolatile memory 13 (Step S5). If the automatic-switching mode is ON (ON at Step S5), the control unit 10 monitors the connection state (Step S6). If the sub-device D1 is disconnected from the main-device P2 (Yes at Step S7), the control unit 10 searches for another connectable main-device P (Step S1) and those steps following Step S1 are repeated.

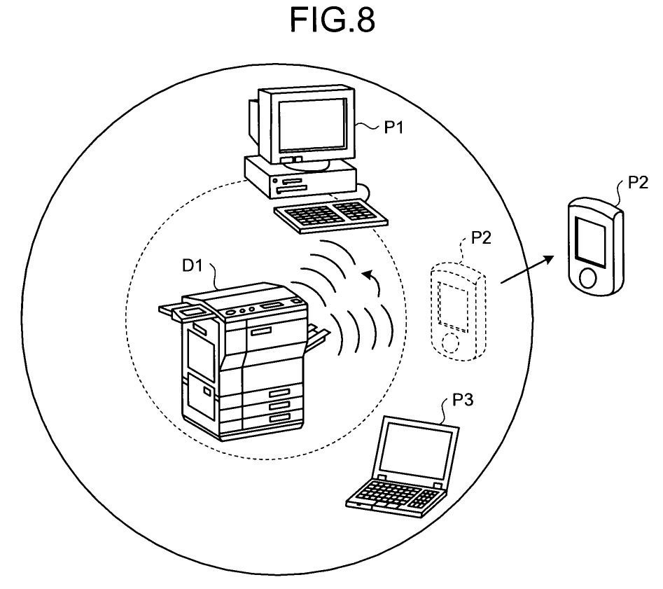

FIG. 8 is a schematic diagram of a situation where the sub-device D1 is disconnected from the main-device P2 as the main-device P2 moves out of the communication range of the sub-device D1. The sub-device D1 detects the main-devices P1 and P3 as the connectable main-devices P at Step S2 after being disconnected from the main-device P2 at Step S7. The control unit 10 reads the priority of the connection information from the nonvolatile memory 13 (Step S3). It is assumed that, as shown in FIG. 4, the main-device P1 has the first priority, the main-device P2 has the third priority, and the main-device P3 has the second priority. The control unit 10 specifies the main-device P1 from among the main-devices P1 and P3 as the target main-device P to be connected because the priority of the main-device P1 is higher than that of the main-device P3, and wirelessly communicates with the main-device P1 (Step S4). As a result, when the sub-device D1 is disconnected from the main-device P, the sub-device D1 automatically switches to another appropriate main-device P based on the priority.

Referring back to FIG. 7, when the sub-device D1 keeps connected to the main-device P that is specified as the target main-device P to be connected at Step S4 (No at Step S7), the control unit 10 searches for the new main-device P connectable to the sub-device D1 but undetected at Step S2 (Step S8). Upon detecting the new main-device P, the control unit 10 determines whether the forced-switching mode is ON by referring to the forced-switch flag stored in the nonvolatile memory 13 (Step S10). If the forced-switching mode is ON (Yes at Step S10), the control unit 10 reads the priority in the connection log-data from the nonvolatile memory 13 (Step S3) and those steps following Step S3 are repeated. The control unit 10 specifies the target main-device P to be connected from among the connectable main-devices P based on the priority acquired at Step S3 (Step S4). More particularly, the control unit 10 compares the priority of the current main-device P with the priority of connectable main-devices P. If at least one out of the connectable main-devices P has the priority higher than that of the current main-device P, the control unit 10 specifies the main-device P having the highest priority from among the connectable main-devices P as the target main-device P to be connected. The control unit 10 wirelessly communicates with the specified main-device P, thereby forcedly switching from the current main-device P to another appropriate main-device P based on the priority.

If the control unit 10 determines at Step S4 that the current main-device P has the highest priority, the sub-device D1 keeps connected to the same main-device P. For example, if the sub-device D1 is connected to the main-device P having the highest priority, i.e., the main-device P1, the sub-device D1 does not switch to another main-device P even when the new main-device P is detected at Step S9.

If the automatic-switching mode is OFF (OFF at Step S5), the control unit 10 stands by until a switch command has been received from the user via the operation panel. When the switch command has been received (Yes at Step S11), the control unit 10 searches for connectable main-devices P other than the main-device P to which the sub-device D1 has been connected most recently (hereinafter, “other connectable main-devices P”) (Step S12). Upon detecting the other connectable main-devices P (Yes at Step S13), the control unit 10 reads the priority in the connection log-data from the nonvolatile memory 13 (Step S14). The control unit 10 specifies the main-device P having the highest priority from among the detected connectable main-devices P as the target main-device P to be connected, and wirelessly communicates with the specified main-device P (Step S15).

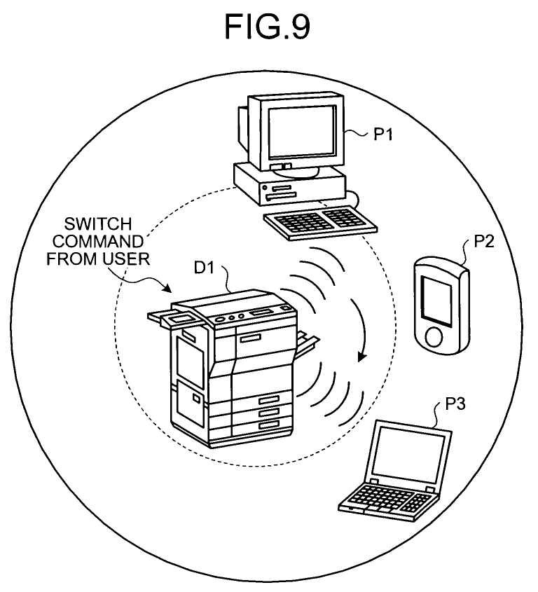

FIG. 9 is a schematic diagram of a situation where the sub-device D1 switches from the current main-device P1 to the main-device P3 in response to a switch command from the user. It is assumed that, as shown in FIG. 9, the main-device P1 is the current main-device P, and the main-devices P2 and P3 are the connectable main-devices P. When the sub-device D1 receives the switch command at Step S11 in the situation shown in FIG. 9, the control unit 10 detects the main-devices P2 and P3 as the other connectable main-devices P. The control unit 10 reads the priority in the connection log-data from the nonvolatile memory 13 (Step S14). The control unit 10 specifies the main-device P3 from among the main-devices P2 and P3 as the target main-device P to be connected because the priority of the main-device P3 is higher than that of the main-device P2, and wirelessly communicates with the main-device P3 (Step S14). As a result, in response to the switch command received from the user, the sub-device D1 switches from the current main-device P, i.e., the main-device P1, to the main-device P3 having the highest priority from among the other connectable main-devices P, i.e., the connectable main-devices P2 and P3.

With this configuration, the sub-device, which shares the connection information with the main-devices having a possibility to make a connection with the sub-device, specifies the appropriate main-device as the target main-device to be connected. For example, when the sub-device is disconnected from a first main-device, the sub-device can automatically switch to a second main-device appropriate based on the priority without maintaining the connection with the first main-device. As a result, when the sub-device is disconnected from the main-device having the high priority, the sub-device switches to another main-device without making the user aware of it, which improves efficient usage of resources such as the main-devices. Moreover, it is assumed that the sub-device is connected to the first main-device having the priority lower than that of a third main-device because the third main-device is not connectable at that time. When the sub-device is disconnected from the first main-device and the third main-device is connectable, the sub-device can switch to the third main-device. Thus, the sub-device can communicate with the more appropriate device.

Furthermore, when the sub-device detects the third main-device while the sub-device is has been connected to the first main-device, the sub-device can switch to the third main-device. Thus, the sub-device can wirelessly communicate with the more appropriate device.

Moreover, even when the sub-device tries to maintaining the connection with the current main-device, the sub-device can switch to another main-device based on the priority if the switch command has been received from the user. Thus, it is possible to switch the target main-device to be connected when the user wishes to switch.

Furthermore, the user can set the switching conditions for switching to another main-device. Thus, it is possible to switch to another main-device based on the priority in a flexible manner as reflecting the intention of the user.

Other wireless communication device can be used as the sub-device D1 instead of an MFP. For example, a printer, a scanner, a facsimile machine, a personal computer, and a mobile information terminal can be used. Moreover, the wireless communication system can include any number of sub-devices and main-devices.

Furthermore, the sub-device D1 stores therein the connection information about each of the main-devices P1 to P3 before performing the specifying process shown in FIG. 7. However, it is enough to store the connection information about at least two from among the main-devices P1 to P3.

Moreover, although the sub-device D1 sets the priority based on the connection log-data, it is allowable to set the priority based on parameters received from the user. For example, the nonvolatile memory 13 stores therein the priority and the connection information in an associated manner. The user sets the priority of each of the main-devices P1 to P3 to a desired value, and inputs the desired values via the operation panel. Upon receiving the desired values from the user, the sub-device D1 updates the priority stored in the nonvolatile memory 13 to the received desired values. The sub-device D1 specifies the target main-device to be connected based on the updated priority stored in the nonvolatile memory 13. Thus, it is possible to use the priority reflecting the intention of the user.

If the user sets the maintaining mode to OFF, the user can additionally set a priority threshold with, for example, a K3 button shown in the setting screen shown in FIG. 6. The priority threshold is used to determine whether the sub-device D1 should switch to another main-device P. Assume that the sub-device D1 is connected to the main-device P2. When the sub-device D1 is disconnected from the main-device P2, the control unit 10 searches for the connectable main-device P, again (Step S1) and Step S2 and S3 are repeated, as described above. After that, the sub-device D1 determines whether the priority of the main-device P2 is equal to or lower than the threshold. If the priority of the main-device P2 is equal to or lower than the threshold, the sub-device D1 determines that sub-device D1 should not switch to another main-device P. In other words, the sub-device D1 stands by until the main-device P2 becomes connectable, and makes a connection with the main-device P2 when the main-device P2 becomes connectable. Assume now that the sub-device D1 detects a new main-device P at Step S9 while the sub-device D1 keeps connected to the main-device P2, and the control process returns to Step S3 because of the forced-switching mode is ON. In this case, the sub-device D1 determines whether the priority of the main-device P2 is equal to or lower than the threshold, after Step S3. If the priority of the main-device P2 is equal to or lower than the threshold, the sub-device D1 determines that the sub-device D1 should not switch to another main-device P. In other words, the sub-device D1 keeps connected to the main-device P2 without switching to another main-device P. Thus, the sub-device D1 can switch to another main-device P in a flexible manner.

In the present embodiment, if the automatic-switching mode is OFF, when the switch command has been received from the user, the sub-device D1 specifies the main-device P having the highest priority from among the other connectable main-devices P as the target main-device P to be connected. However, it is allowable to specify the main-device P having the priority next to that of the main-device P to which the sub-device D1 has been connected most recently as the target main-device P to be connected. More particularly, assume that the sub-device D1 is connected to the main-device P1 having the first priority. Upon receiving the switch command, the sub-device D1 specifies the main-device P3 having the second priority as the target main-device P to be connected, and switches to the main-device P3. Upon receiving the switch command while the sub-device D1 is connected to the main-device P3, the sub-device D1 specifies the main-device P2 having the third priority as the target main-device P to be connected. Thus, the sub-device D1 can switch to the target main-device to be connected in a flexible manner when the user wishes to switch.

Even if the automatic-switching mode is ON, the sub-device D1 can switch to the main-device P having the highest priority from among the other connectable main-devices P in response to the switch command received from the user. More particularly, if the automatic-switching mode is ON at Step S5, the sub-device D1 checks whether the switch command has been received while monitoring the connection state. Upon receiving the switch command, the sub-device D1 specifies the target main-device P to be connected.

The computer programs executed by the sub-device D1 can be stored in another computer connected to the computer via a network such as the Internet, and downloaded to the computer via the network. Alternatively, the computer programs can be stored, in a form of a file that is installable and executable on a computer, in a recording medium readable by the computer, such as a compact disk-read only memory (CD-ROM), a flexible disk (FD), and a digital versatile disk (DVD).

Although the nonvolatile memory 13 stores therein the connection log-data and the connection information, the RAM 11 or the ROM 12 can store therein those data instead of the nonvolatile memory 13. Moreover, it is allowable to store the connection log-data in one storage unit and the connection information in another storage unit.

According to an embodiment of the present invention, a communication apparatus working as a sub-device stores therein connection information about a plurality of other communication apparatuses working as main-devices. The sub-device specifies an appropriate one of the main-devices as a target main-device to be connected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus that works as a sub-device and wirelessly transmits/receives encrypted device identification data and encrypted communication data to/from a plurality of communication apparatuses that works as main-devices, the communication apparatus working as the sub-device comprising:
a storage unit that stores therein connection information that includes an encryption key and device identification data, the encryption key being used to encrypt information to be transmitted;
a detecting unit that detects a main device connectable to the sub-device;
a specifying unit that specifies, when the detecting unit detects a first main-device and a second main-device as main devices connectable to the sub-device, the first main-device as a target main-device to be connected from among the first main-device and the second main-device based on priority information about the first main-device and the second main-device; and
a communicating unit that wirelessly communicates with the target main-device by using the connection information corresponding to the target main-device in the storage unit, wherein
when the detecting unit detects a third main-device connectable to the sub-device while the communicating unit is communicating with the first main-device, the specifying unit re-specifies a target main-device to be connected from among the main-devices connectable to the sub-device based on the priority.

2. The communication apparatus according to claim 1, wherein when the sub-device is disconnected from the first main-device, the specifying unit specifies the target main-device from among the main-devices connectable to the sub-device detected by the detecting unit based on the priority.

3. The communication apparatus according to claim 1, further comprising:
a first storing control unit that stores connection log-data in the storage unit, the connection log-data indicative of a log of connection with each of the main-devices; and
a first priority storing unit that calculates the priority from the connection log-data in the storage unit and stores calculated priority in the storage unit in associated with the connection log-data, wherein
the specifying unit specifies the target main-device based on the priority in the storage unit.

4. The communication apparatus according to claim 3, wherein
the connection log-data includes at least one from among items including frequency of previous connection, amount of data to be transferred at previous connection, elapsed time since a first connection, elapsed time since a latest connection, and type of application that is used at previous connection,
the first priority storing unit calculates the priority from at least one item of the connection log-data as a priority parameter and stores the calculated priority in the storage unit, and
the specifying unit specifies the target main-device based on the priority in the storage unit.

5. The communication apparatus according to claim 4, further comprising a receiving unit that receives a command from a user, wherein
when the receiving unit receives a setting command to specify at least one item of the connection log-data as the priority parameter, the first priority storing unit calculates the priority from specified priority parameter and stores the calculated priority in the storage unit.

6. The communication apparatus according to claim 1, further comprising a second priority storing unit that calculates the priority from the device identification data in the connection information and stores calculated priority in the storage unit, wherein
the specifying unit specifies the target main-device based on the priority in the storage unit.

7. The communication apparatus according to claim 1, wherein when the detecting unit detects the third main-device connectable to the sub-device while the communicating unit is communicating with the first main-device, the specifying unit re-specifies the target main-device by comparing the priority of the first main-device and the priority of the main-devices connectable to the sub-device detected by the detecting unit.

8. The communication apparatus according to claim 1, further comprising:
a receiving unit that receives a command from a user; and
a second storing control unit that updates, when the receiving unit receives a setting command to set a switching mode to ON/OFF, a switch flag stored in the storage unit to ON/OFF based on the setting command, wherein
when the switch flag is ON, the specifying unit re-specifies the target main-device to be connected.

9. The communication apparatus according to claim 1, further comprising a receiving unit that receives a command from a user, wherein when the receiving unit receives a switch command to switch to another main-device while the communicating unit is communicating with the first main-device,
the detecting unit detects a main-device connectable to the sub-device other than the first main-device, and
the specifying unit re-specifies, if the detecting unit detects a plurality of main-devices connectable to the sub-device other than the first main-device, the target main-device to be connected from among the main-devices detected by the detecting unit based on the priority.

10. The communication apparatus according to claim 1, further comprising:
a receiving unit that receives a command from a user; and
a third storing control unit that updates, when the receiving unit receives a setting command to set a value indicative of the priority, the value indicative of the priority stored in the storage unit based on the setting command.

11. The communication apparatus according to claim 1, wherein when the sub-device is disconnected from the first main-device and the specifying unit re-specifies the target main-device to be connected, the communicating unit communicates with the target main-device to be connected re-specified by the specifying unit.

12. A communication method of communicating between a communication apparatus that works as a sub-device and wirelessly transmits/receives encrypted device identification data and encrypted communication data to/from a plurality of communication apparatuses that works as main-devices, the communication apparatus working as the sub-device performing:
detecting a main device connectable to the sub-device;
specifying, when a first main-device and a second main-device are detected at the detecting as main devices connectable to the sub-device, the first main-device as a target main-device to be connected from among the first main-device and the second main-device based on priority information about the first main-device and the second main-device; and
establishing wirelessly communication with the target main-device by using the connection information corresponding to the target main-device stored in a storage unit, wherein
when a third main-device connectable to the sub-device is detected at the detecting while the communicating unit is communicating with the first main-device, the specifying includes re-specifies a target main-device to be connected from among the main-devices connectable to the sub-device based on the priority.

13. The communication method according to claim 12, wherein when the sub-device is disconnected from the first main-device, the specifying includes specifying the target main-device from among the main-devices connectable to the sub-device detected at the detecting based on the priority.

14. The communication method according to claim 12, further comprising:
storing connection log-data in the storage unit, the connection log-data indicative of a log of connection with each of the main-devices; and
calculating the priority from the connection log-data in the storage unit, and storing calculated priority in the storage unit in associated with the connection log-data, wherein
the specifying includes specifying the target main-device based on the priority in the storage unit.

15. The communication method according to claim 14, wherein
the connection log-data includes at least one from among items including frequency of previous connection, amount of data to be transferred at previous connection, elapsed time since a first connection, elapsed time since a latest connection, and type of application that is used at previous connection,
the calculating includes calculating the priority from at least one item of the connection log-data as a priority parameter and storing the calculated priority in the storage unit, and
the specifying includes specifying the target main-device based on the priority in the storage unit.

16. The communication method according to claim 15, further comprising receiving a command from a user, wherein
when the command received at the receiving is a setting command to specify at least one item of the connection log-data as the priority parameter, the calculates includes calculating the priority from specified priority parameter and storing the calculated priority in the storage unit.

17. The communication method according to claim 12, further comprising calculates the priority from the device identification data in the connection information and storing calculated priority in the storage unit, wherein
the specifying includes specifying the target main-device based on the priority in the storage unit.

18. The communication method according to claim 12, wherein the third main-device connectable to the sub-device is detected at the detecting while the communicating unit is communicating with the first main-device, the specifying includes re-specifies the target main-device by comparing the priority of the first main-device and the priority of the main-devices connectable to the sub-device detected at the detecting unit.

19. The communication method according to claim 12, further comprising:
receiving a command from a user; and
updating, when the command received at the receiving is a setting command to set a switching mode to ON/OFF, a switch flag stored in the storage unit to ON/OFF based on the setting command, wherein
when the switch flag is ON, the specifying includes re-specifies the target main-device to be connected.

20. The communication method according to claim 12, further comprising receives a command from a user, wherein when the command received at the receiving is a switch command to switch to another main-device while the communicating unit is communicating with the first main-device,
the detecting includes detecting a main-device connectable to the sub-device other than the first main-device, and
the specifying includes re-specifies, a plurality of main-devices connectable to the sub-device other than the first main-device is detected at the detecting, the target main-device to be connected from among the main-devices detected at the detecting based on the priority.
